(19) United States
(12) Patent Application Publication
(10) Pub. No.: US 2011/0121564 A1
(43) Pub. Date: May 26, 2011

(54) ADJUSTABLE SWIVEL FLUID CONDUIT PATHWAY

(76) Inventor: Ira Harold Kaplan, Buffalo Grove, IL (US)

(21) Appl. No.: 12/950,937

(22) Filed: Nov. 19, 2010

Related U.S. Application Data
(60) Provisional application No. 61/281,762, filed on Nov. 23, 2009.

(51) Int. Cl. F16L 27/04

(52) U.S. Cl. 285/263

(57) ABSTRACT

An adjustable swiveled fluid conduit pathway having a plurality of interconnecting joints for securing a pressurized fluid line in a predetermined path is provided. The adjustable swiveled fluid conduit pathway is particularly suitable for securing a mid to high-pressure coolant fluid line in, for example, a computer numerically controlled (CNC) grinding machine. A plurality of interconnecting joints comprise the pathway. The interconnecting joints each have two ball joint assembly units having an interior pathway for a fluid (aligned ball portion facing ball portion) and a nut housing unit. A washer and bushings are located, under pressure, between the two balls of the ball-joint assembly units. The adjustable swiveled fluid conduit pathway may be extended or shortened by the addition or removal of an interconnecting joint (or link). The adjustable swiveled fluid conduit pathway is secured in the pre-determined position by securing the interconnecting joints at a specific desired angle.

### CROSS REFERENCE TO RELATED APPLICATIONS

The present application claims priority benefit of U.S. Provisional Application 61/281,762, filed on Nov. 23, 2009, which is hereby incorporated by reference in its entirety.

### BACKGROUND OF THE INVENTION

An adjustable swiveled fluid conduit pathway having a plurality of interconnecting joints for securing a pressurized fluid line in a predetermined path is provided. The adjustable swiveled fluid conduit pathway is particularly suitable for securing a mid to high-pressure coolant fluid line in, for example, a computer numerically controlled (CNC) grinding machine. A plurality of interconnecting joints comprise the pathway. The interconnecting joints each have two ball-joint assembly units having an interior pathway for a fluid (aligned ball portion facing ball portion) and a nut housing unit. A washer is located, under pressure, between the two balls of the ball-joint assembly units. The adjustable swiveled fluid conduit pathway may be extended or shortened by the addition or removal of an interconnecting joint (or link). The adjustable swiveled fluid conduit pathway is secured in the pre-determined position by securing the interconnecting joints at a specific desired angle. The nut housing unit has a cylinder having two bushings and an internal o-ring washer. Tightening two nut units over the nut housing unit and ball joint assembly units creates pressure which forces the bushings against the o-ring washer. This pressure forces the ball-assembly units within the nut housing unit to be secured in the desired position. The adjustable swiveled fluid conduit is especially suitable for delivering a fluid jet. For example, a fluid can be delivered to a rotating grinding wheel on a mechanical grinding machine so as to properly lubricate and cool the grinding wheel and part being ground.

The conduit incorporates the theories of Rouse to provide a more coherent jet stream when used with a nozzle designed to eliminate air when fluid exits the line. This allows the cutting wheel and the part being ground to be cooled and lubricated better than other flexible conduits currently in use.

Attempts have been made to provide fluid connectors which are capable of being bent at a predetermined position. For example, U.S. Pat. No. 5,127,681 to Thelen et al. discloses a connector for sealingly joining together lengths of tubing such as those used in automobile fluid conveying systems. The system accommodates large angular bending and twisting motions as a result of a spherical shell which rotates inside guide/thrust circumferential bearings. Noise and vibration damping are achieved by an elastomeric pad of non-uniform thickness bonded between the spherical shell and an enlargement formed on one of the lengths of tubing.

And U.S. Pat. No. 3,957,291 to Edling discloses a multi-passage ball joint assembly for connecting a riser or similar pipe to a well pipe there below and adapted primarily for use in underwater installations. The ball member of the joint assembly has a main longitudinal bore or passage through which well operations may be conducted and additionally is formed with at least one other passage for conducting fluid there through. The housing of the joint assembly includes passageways which are in communication with the bore and passages extending through the ball member in all positions of said ball member relative to the housing whereby fluid may be conducted downwardly through the ball joint for actuating devices there below or for other purposes. This abstract is neither intended to define the invention of the application which, of course, is measured by the claims, nor is it intended to be limiting as to the scope of the invention in any way.

U.S. Pat. No. 4,139,221 to Shotbolt discloses a ball and socket joint comprising a member having forward facing and rear facing spherical surface portions, a collar engaged about the member and having internal surface portions mating with the spherical surface portions of the member, a socket into which is received the previously formed assembly comprising the member with the collar engaged thereabout, and securing means for securing the assembly in the socket. The ball and socket joint being constructible as a pipe coupling, particularly a pipe coupling for use in difficult working environments such as a deep subsea location, the securing means can be constructed for remote operation and can be constructed for applying to the assembly a continuous pre-load force tending to push the assembly into the socket. A pipeline laying method suited to laying underwater pipelines of length up to about 12,000 feet for which conventional methods such as by the use of a lay barge may be uneconomic, or for laying pipelines under ice floes, comprises using a relatively small surface or submarine vessel to lay pipes up to about 500 feet in length with the components of ball and socket pipe couplings previously assembled to the ends of each pipe, and then joining the coupling component at one end of each pipe, after the pipe has been laid, to the mating component at the free end of the previously laid pipe.

To change the angle of the pathway of the present device and system, one may loosen the nut housing, move the pathway to a new position, and then retighten the nut housing. The problem with many past fluid conduit connector devices is that they fail to provide a reliable fluid pathway which can be secured under the mid to higher pressures required for the operation of certain grinding and milling machines and machining centers. In addition, existing fluid conduit pathways made up of segments do not provide a manner in which to easily hold the geometry of pathway while still being able to change the conduit length easily. Even further, existing fluid conduit pathways often do not retain their proper angles and coherence under the newer mid to high-pressure conditions. A need, therefore, exists for an improved adjustable fluid conduit pathway for use in, for example, a computer numerically controlled (CNC) grinding machine.

### SUMMARY OF THE INVENTION

An adjustable swiveled fluid conduit pathway having a plurality of interconnecting joints for securing a pressurized fluid line in a predetermined path is provided. The adjustable swiveled fluid conduit pathway is particularly suitable for securing a mid to high-pressure coolant fluid line in, for example, a computer numerically controlled (CNC) grinding machine. A plurality of interconnecting joints comprise the pathway. The interconnecting joints each have two ball joint assembly units having an interior pathway for a fluid (aligned ball portion facing ball portion) and a nut housing unit. A washer is located, under pressure, between the two balls of the ball-joint assembly units. The adjustable swiveled fluid conduit pathway may be extended or shortened by the addition or removal of an interconnecting joint (or link). The adjustable swiveled fluid conduit pathway is secured in the pre-determined position by securing the interconnecting joints at a specific desired angle. The nut housing unit has a cylinder having two bushings and an internal o-ring washer. Tightening two nut units over the nut housing unit and ball joint assembly units creates pressure which forces the bushings against the o-ring washer. This pressure forces the ball-assembly units within the nut housing unit to be secured in the desired position. The adjustable swiveled fluid conduit is especially suitable for delivering a fluid jet. For example, a fluid can be delivered to a rotating grinding wheel on a mechanical grinding machine so as to properly lubricate and cool the grinding wheel and part being ground.

An advantage of the present adjustable swiveled fluid conduit system is that the system may stand up to much higher pressures than other adjustable swiveled fluid conduit systems.

Yet another advantage of the present adjustable swiveled fluid conduit system is that the system may be easily made to alter direction.

Still another advantage of the present adjustable swiveled fluid conduit system is that the system may be expanded or reduced in length easily.

And another advantage of the present adjustable swiveled fluid conduit system is that the system maintains a much more coherent jet when existing the nozzle end than other adjustable swiveled fluid conduit systems.

And another advantage of the present adjustable swiveled fluid conduit system is that the system may be installed easily and quickly.

An advantage of the present adjustable swiveled fluid conduit system is that the system may be transported easily.

In an embodiment, the adjustable swiveled fluid conduit is easily extended or shortened by the addition or removal of some of the ball joint connectors.

In yet another embodiment, the adjustable swiveled fluid conduit may be easily secured at alternative predetermined angles.

In still another embodiment, the adjustable swiveled fluid conduit may be secured at a specific location while fluid travels through the adjustable swiveled fluid conduit at a mid to high pressure.

For a more complete understanding of the above listed features and advantages of the adjustable swivel fluid conduit, reference should be made to the following detailed description of the preferred embodiments and to the accompanying drawings. Further, additional features and advantages of the present invention are described in, and will be apparent from, the detailed description of the preferred embodiments and from the drawings.

### BRIEF DESCRIPTION OF THE DRAWINGS

FIG. 1 illustrates a side plan view of a portion of the adjustable swiveled fluid conduit.

FIG. 2 illustrates a side view of the nut housing holder wherein the ball-joint assembly units are not present.

FIG. 3 illustrates a side plan view of a nut portion of the adjustable swiveled fluid conduit line.

FIG. 4 illustrates a side plan view of the nut in its environment in the conduit line.

FIG. 5 illustrates a side plan view of the nut portion of the adjustable swiveled fluid conduit line.

FIG. 6 illustrates a detailed side plan view of a close up of a portion of the adjustable swiveled fluid conduit.

FIG. 7 illustrates a side plan view of the nut portion of the fluid conduit in association with a cylindrical portion of the line.

FIG. 8 illustrates a side plan view of the conduit line wherein a first nut is at an angle with respect to the second nut and the direction of the conduit line is changed.

FIG. 9 illustrates a side plan view of two nuts of the conduit line being connected together via a cylindrical attachment.

FIG. 10 illustrates a plan side of one half of the nut housing holder with the external threads missing wherein one of the bushings is used.

FIG. 11 illustrates a side plan view of the entire conduit line.

FIG. 12 illustrates a side plan view of an embodiment wherein the nut housing holder is lacking.

FIG. 13 illustrates a side plan view two nuts of the conduit line connected via a connecting unit.

FIG. 14 illustrates a side plan view of two nut portions being attached to a connecting unit.

FIG. 15 illustrates a side plan view of the conduit line wherein the line is curved at an angle between 100 and 130 degrees.

FIG. 16 illustrates an elongated view of the conduit line having multiple connection points.

FIG. 17 illustrates a top cross-section view of the nut of the conduit wherein the nut has six sides on the exterior surface.

FIG. 18 illustrates a top cross-section view of the nut of the conduit wherein the nut has a generally cylindrical exterior surface.

FIG. 19 illustrates a detailed side plan view of a connection point of the system wherein the nut portions are being secured over the nut housing holder.

FIGS. 20a, b and c illustrates the path of a fluid through a ball joint assembly.

### DETAILED DESCRIPTION OF THE PREFERRED EMBODIMENTS

An adjustable swiveled fluid conduit pathway having a plurality of interconnecting joints for securing a pressurized fluid line in a predetermined path is provided. The adjustable swiveled fluid conduit pathway is particularly suitable for securing a mid to high-pressure coolant fluid line in, for example, a computer numerically controlled (CNC) grinding machine. A plurality of interconnecting joints comprise the pathway. The interconnecting joints each have two ball joint assembly units having an interior pathway for a fluid (aligned ball portion facing ball portion) and a nut housing unit. A washer is located, under pressure, between the two balls of the ball-joint assembly units. The adjustable swiveled fluid conduit pathway may be extended or shortened by the addition or removal of an interconnecting joint (or link). The adjustable swiveled fluid conduit pathway is secured in the pre-determined position by securing the interconnecting joints at a specific desired angle. The nut housing unit has a cylinder having two bushings and an internal o-ring washer. Tightening two nut units over the nut housing unit and ball-joint assembly units creates pressure which forces the bushings against the o-ring washer. This pressure forces the ball-assembly units within the nut housing unit to be secured in the desired position. The adjustable swiveled fluid conduit is especially suitable for delivering a fluid jet. For example, a fluid can be delivered to a rotating grinding wheel on a mechanical grinding machine so as to properly lubricate and cool the grinding wheel and part being ground.

Although the pressures may vary a great deal depending on the type of pipe or hose used or the desired purpose of the line, the following pressure chart for standard coolant pressures used for lines over the years is given as examples:

Approximate pressures to grind/machine:
(shortened line in beginning 1 space)

| | |
|---|---|
| Pressure used from 1930 to about 1950 | City supplied pressure |
| Pressure used from 1950 to 1965 | 60 psi (pump) |
| Pressure used from 1965-1975 | 80 psi (pump) |
| Pressure used from 1975-1990 | 80 psi to 100 psi (pump) |
| Pressure from 1990-2000 | 80 to 120 psi (pump) |
| Pressure used from 2000 to 2003 | 100 to 180 psi (pump) |
| Pressure used from 2003 to present | 120 to 250 psi (pump) |

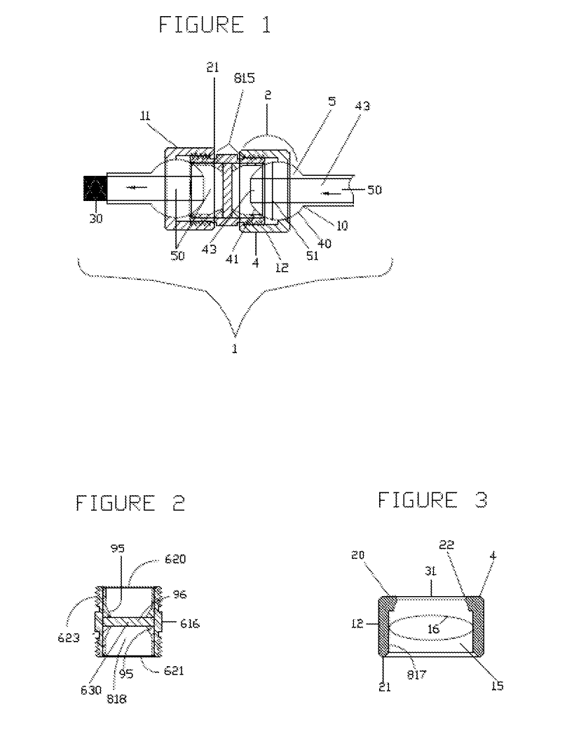

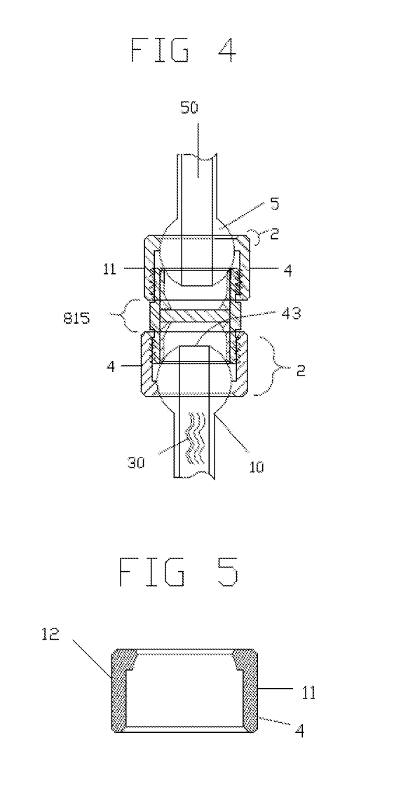

Referring now to FIGS. 1-3, in an embodiment, the swiveled fluid conduit pathway 1 may have a plurality of interconnected ball-joint assembly units 2. The swiveled fluid conduit pathway 1 is preferably constructed from a corrosive-resistant or corrosive-proof metal, such as brass, stainless steel, plastic or another non-corrosive material. FIG. 3 illustrates the nut 4 of the system 1 by itself.

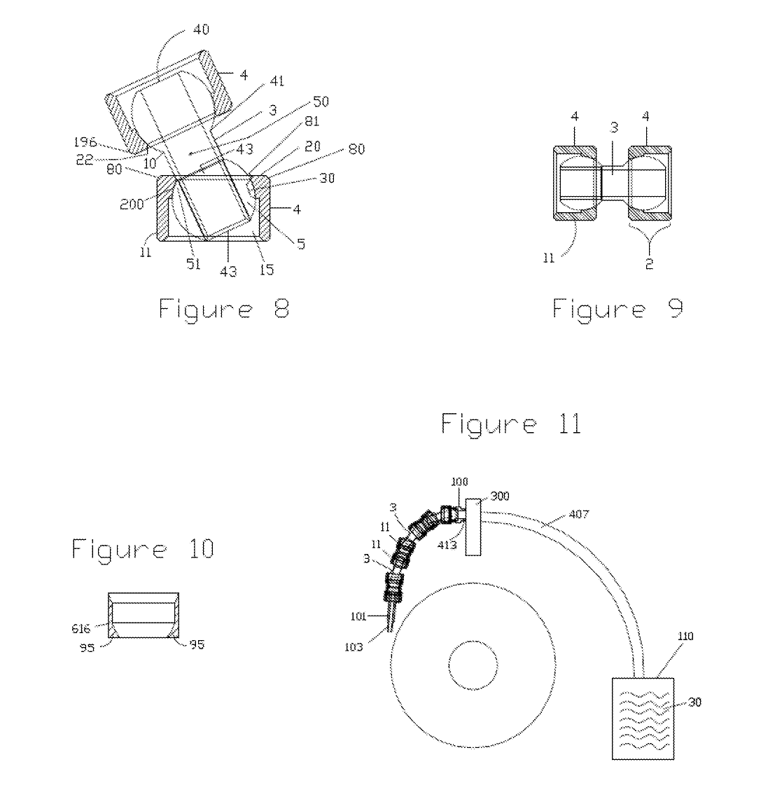

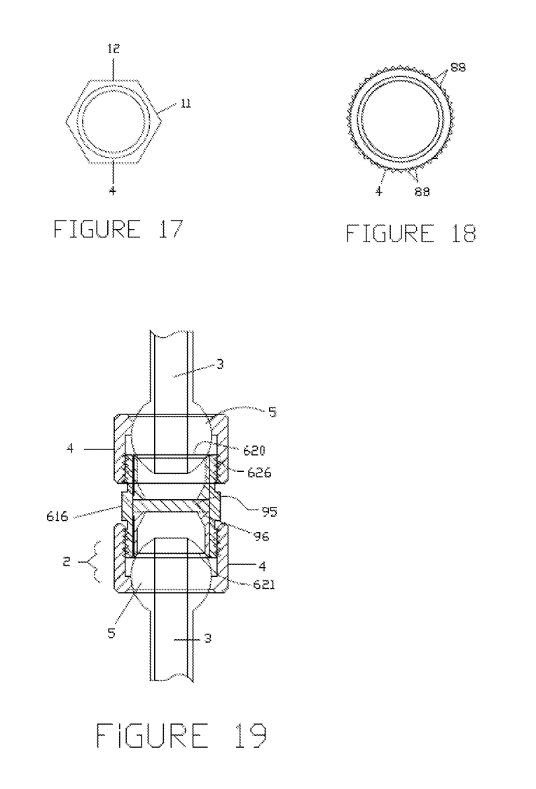

The ball joint assembly unit 2 may have a nut portion 4 and a ball portion 5. The ball portion 5 may be located, for example, at both distal ends 10 of the generally straight cylindrical portion 3 (FIG. 8). The generally cylindrical portion 3 may have an interior passageway 50 which may allow, for example, a pressurized fluid (or other object) to pass through the center, similar to that of a liquid flowing through a pipe. In an embodiment, the nut portion 4 may have an exterior 11 having a series of flat surfaces 12 (FIG. 17). More specifically, the series of flat surfaces 12, may be similar to the flat surfaces of the outer wall of a typical nut which may be secured around a typical bolt. The flat surfaces 12 may allow the user to easily tighten the nut portion 4 in a predetermined position by using a standard wrench or the fingers of the user.

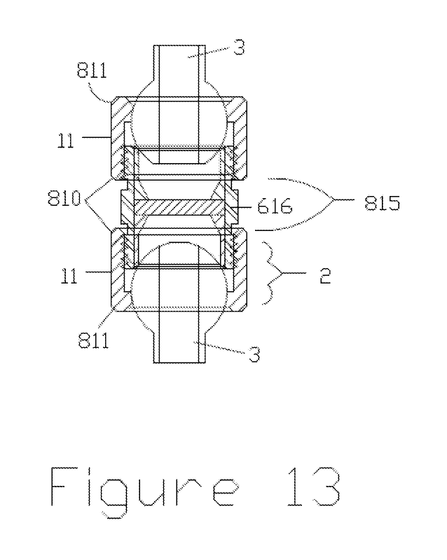

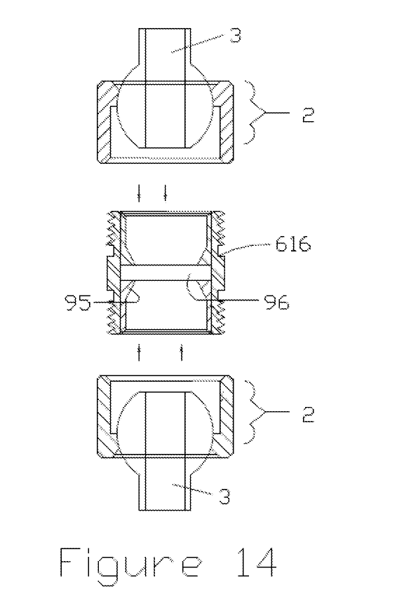

Referring now to FIG. 13, the ball-joint assembly units 2 may have a first end 810 and a second end 811. While assembled in the adjustable swiveled fluid conduit 1 passageway system, the first end 810 of a first ball joint assembly unit 2 may face the first end 810 of a second ball joint assembly unit 2. More specifically, the two ball joint assembly units 2 may mirror each other in orientation. The first ends 810 of the ball-joint assembly units 2 may fit over and may be secured around a nut housing holder 616 (as described below). The second ends 811 of the ball joint assembly units 2 may extend away from the nut housing holder 616 and may partially cover the generally cylindrical portion 3 of the adjustable swiveled fluid conduit 1 passageway system (as described below). The two ball joint assembly units 2 and nut housing holder 616 may move as a single unit while the adjustable swiveled fluid conduit 1 passageway system may alter direction between the ball joint assembly unit 2 and the generally cylindrical portion 3. The generally cylindrical portion 3 may be located between two ball joint assembly units 2 which are not secured on the same nut housing holder 616, but located on different nut housing holders 616.

In an alternative embodiment, the exterior 11 of the nut portion 4 may be cylindrical (FIG. 18) and may have a plurality of largely parallel ridges 88 which may allow for easy grasping and tightening via a wrench or fingers. As illustrated in FIG. 17, the exterior 11 of the nut portion 4 may have six sides; however, it should be noted that the exterior 11 of the nut portion 4 may have any number of sides or may be knurled for tightening by hand or with the use of a tool.

Referring now to FIG. 3, a nut portion 4 may have a generally hollow interior forming a pathway which may extend from a first side 20 to a second side 21. The generally hollow interior 15 passageway of the nut portion 4 may be generally cylindrical in shape. More specifically, the interior 15 passageway of the nut portion 4 may have a circumference 16 which may define the interior wall of the nut portion 4. The first side of the nut portion 4 may have a lip 22 which may extend inward toward a center 31 of the nut portion 4. More specifically, the lip 22 may to cover a portion of the passageway on the first side 20 of the nut portion 4 and the lip 22 may be lacking on the second side 21 of the nut portion 4. The nut portion 4 may partly be secured over and around a portion of the nut housing holder 616 (as described below). The nut portion 4 has a series of flats or a knurl on the outside, which aids in the tightening of the nut portion 4.

The ball portion 5 of the ball-joint assembly units 2 may resemble a bead on a necklace. More specifically, the ball portion 5 may have a first side 40 and a second side 41. The first side 40 and the second side 41 may each have an opening 43 creating a passageway through the interior of the ball portion 5 wherein a pressurized fluid 30 may flow through the interior. The first side 40 of the ball portion 5 may be permanently secured to one of the distal ends 10 of the generally straight cylindrical portions 3. As a result, a fluid 30 may pass through the passageway 50 of the generally cylindrical portion 3 and on through the ball portion 5 of the system 1.

The ball portion 5 of the adjustable swiveled fluid conduit 1 passageway may be partly secured within the interior 15 of the nut portion 4 and partly within the interior 818 (FIG. 2) of the nut housing holder 616. More specifically, the ball portion 5 may have an exterior circumference 51 which is slightly less than the circumference 16 which defines an interior wall 817 (FIG. 3) of the nut portion 4. Because of the rounded exterior of the ball portion 5, the ball portion (and attached generally cylindrical portion 3) may rotate with respect to the stationary nut portion 4. FIG. 8 illustrates the ball portion 5 and generally cylindrical portion 3 rotating approximately twenty to thirty degrees with respect to the nut portion 4. The lip 22 of the nut portion 4 may prevent the ball portion 5 from exiting the interior 15 of the nut portion 4.

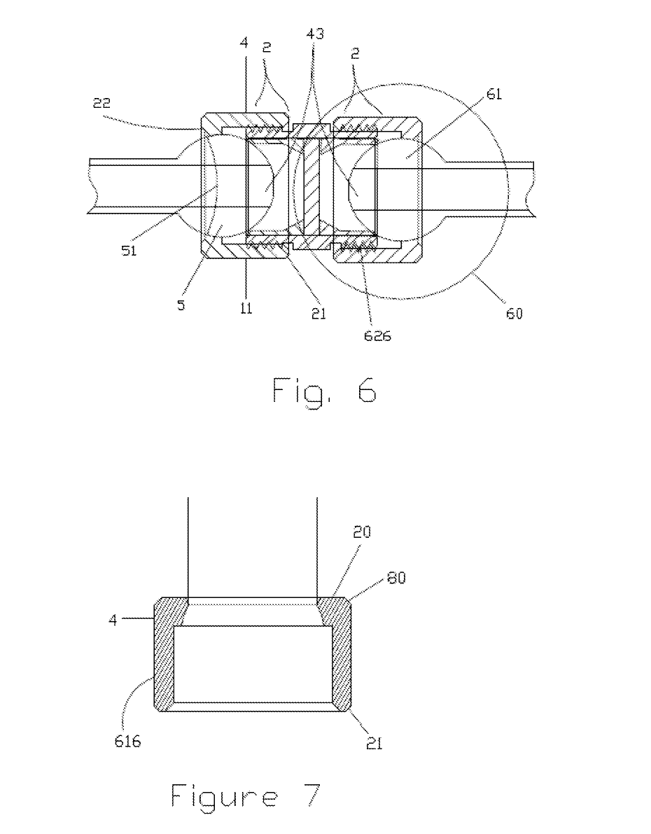

Referring to FIG. 6, near the second end 21 of the nut portion 4 may be a second nut portion 60 having similar qualities as the first nut portion 4 except in a mirror image orientation. A second ball joint 61 may be secured within the interior of the second nut portion 60 and may extend outward in the opposite direction as the first ball portion 5.

The entire adjustable swiveled fluid conduit 1 may be extended by using any number of ball portions 5, cylindrical portions 3, and nut portions 4, ball-joint assembly units 2 and nut housing holders 616. The greater the number of corresponding ball portions 5 and nut portions 4 the longer the adjustable swiveled fluid conduit 1 passageway and the greater the ability to secure the adjustable swiveled fluid conduit 1 in a predetermined configuration. In addition, the greater the number of corresponding ball portions 5 and nut portions 4, the greater the flexibility of the conduit 1 becomes as the total angle of each connection point is added to all previous connections.

Once the adjustable swiveled fluid conduit pathway 1 is secured in a desired position, such as aimed at a grinding machine work-piece, the device may be secured by tightening the nut portions 4 (around the ball portion 5 and) on the nut housing holder 616. More specifically, the adjustable swiveled fluid conduit 1 may be tightened by, for example, a wrench (as might be done in FIG. 17) or a hand (as might be done in FIG. 18). The entire assembly may be aimed by hand and the internal pressure created by the parts. In an embodiment, the pressure created by the fluid 30 may not hold the assembly in place; instead, the washer 96 and parts may hold the assembly in the desired configuration.

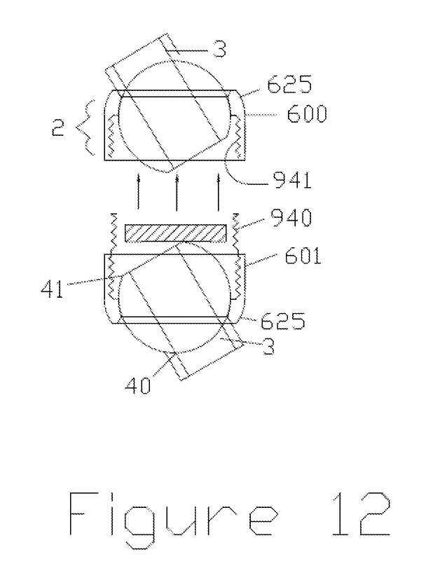

Referring now to FIG. 11, a first distal end 101 of the adjustable swiveled fluid conduit 1 may have an adjustable nozzle 102 which may, for example, be tapered 103 on the exterior surface so as the nozzle may fit into tight spaces, as is common in computer numerically controlled (CNC) grinding machines. The narrow stream is aimed at a desired location such as, for example, a grinding wheel 444. The second distal end 100 of the adjustable swiveled fluid conduit 1 may be attached to a manifold 300 which may be attached to a coolant delivery line 407 and then to a fluid reservoir 110 which may supply the fluid 30 which passes into the adjustable swiveled fluid conduit 1 and exits at the nozzle 102.

Referring now to FIG. 8, the nut portion 4 may have a chamfer (or radius) 80 located at the first side 20 of the nut 4. The chamfer (or radius) 80 may eliminate the edge of the nut 4 so that edge of the nut 4 does not come into contact with the straight cylindrical portion 3 or another nut 196 in the assembly. The interior 15 of the nut portion 4 may have a curved wall 200. The curved wall 200 may have a near identical circumference as the circumference 51 of the ball 5 so that an air or fluid 30 tight seal is created between the ball portion 5 and the nut portion 4. As a result, air and/or fluid 30 are stopped from exiting the nut portion 4 without passing through the openings 43 at the ends of the ball portion 5. Also located on the first side 20 of the nut portion 4 may be a downward taper 81. Whereas the chamfer 80 may be located on the distal portion of the nut portion 4, the downward taper 81 may be located toward the inward portion of the nut portion 4. More specifically, the downward taper 81 may be located at the opening of the nut portion 4.

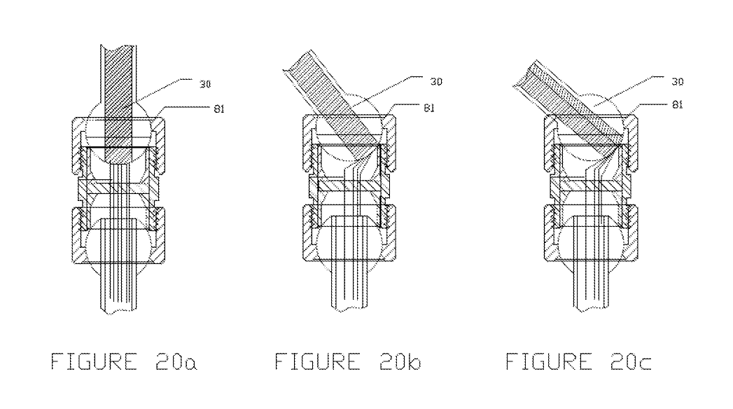

The ball portion 5 and generally cylindrical straight portion 3 are attached as one secure piece. The ball portion 5/generally cylindrical straight portion 3 move as a single unit within the nut portion 4. As a result of the downward taper 81, the ball portion 5/generally cylindrical straight portion 3 may rotate to a greater extent within the opening of the nut portion 4. The rotation may be, for example, around twenty to thirty degrees in any direction from a vertical position. The downward taper 81 may also act as a stop preventing the ball portion 5/generally cylindrical straight portion 3 from moving beyond a pre-determined angle. As a result of the taper, the ball portion 5/generally cylindrical straight portion 3 may not be rotated off a vertical axis of the nut portion 4 and prevented from creating too great an angle to interfere with the conduit's fluid function, thereby allowing the conduit to be flexible. As show in FIG. 20a, the fluid may travel through the conduit 1 without a reduction in the pathway diameter.

The nut portion 4 is secured around cylindrical portion 3. The cylindrical portions 3 may allow the ball-joints to be connected in a series or, alternatively, the cylindrical portion 3 may connect to a terminal nozzle 101 or to an adapter 413 (FIG. 11). The adapter 413 may allow the swiveled fluid conduit pathway 1 to be secured to a manifold 300. The manifold 300 may connect the swiveled fluid conduit pathway 1 (via the adapter 413) to the coolant delivery line 407.

Referring now to FIG. 2, in an embodiment, a nut housing holder 616 is provided. The nut housing holder 616 may have a first end 620 and a second end 621 and may have a passageway allowing fluid to pass through the same. The first end 620 and the second end 621 may be largely identical. The nut housing holder 616 may be generally cylindrical in shape and may be a physical structure for the nut portions 4 to secure onto during use of the system. An exterior of the nut housing holder 616 may have threads 623 which may correspond to interior threads 626 (or grooves) within the nut portion 4 (FIG. 19). As a result, a first nut portion 4 may be secured over the first end 620 of the nut housing holder 616 and a second nut portion 4 may be secured over the second end 621 of the nut housing holder 616 via the threads 623. The nut portions 4 may be secured over the nut housing holder 616 by, for example, friction and pressure created by the passage of fluid 30 through the system 1.

The nut housing holder 616 may have a middle 630. Near the middle 630 of the nut housing holder 616 may be a washer 96 and two bushings 95. The washer 96 may be located between the two bushings 95. Further, in use, the bushings 95 may be located between the washer 96 and the ball portions 5. As a result, within the nut housing holder 616 may be: the first ball portion 5, then a first bushing 95, then the washer 96, then the second busing 95 and then the second ball portion 5. Finally, the nut portions 4 may be secured over each end of the nut housing holder 616.

The top of the bushing 95 may have a radius equal to or slightly greater than the ball 5. This feature may allow the fluid 30 to be contained between the ball 5 and the bushing 95 when downward pressure is applied from the nut portion 4. A hole in the bushing 95 may be equal to the diameter of the washer 96 which separates the bushing 95 from a second bushing 95 facing towards the second ball. The washer 96 may be located between the bushings 95 to hold the downward pressure created by the nut portion 4 making the entire conduit's pressure set for adjustment by hand.

As stated above, the washer 96 may be located between the bushings 95. The tightening of the nut portions 4 may force the bushings 95 toward the washer 96, thereby creating a tight seal wherein the fluid 30 cannot escape from the fluid conduit system 1. When this happens, the washer 96 becomes compressed and further increases the seal and reduces the likelihood of the fluid 30 unintentionally exiting the fluid conduit system 1. Because the washer 96 may be constructed from, for example, rubber, the washer 96 may give greater in some areas and less in some areas such that a liquid tight seal is created within the interior 15 of the nut portion 4.

As stated above, the swiveled fluid conduit pathway 1 may have an adapter 413. The adapter 413 allows the swiveled fluid conduit pathway 1 to be joined to the manifold 300. The manifold 300 allows the system to be connected to the coolant delivery line 407 which is, in turn, connected to a fluid source 110. Typically, the adapter 413 has threads that thread into the manifold 300, but the two may be joined by other means such as soldering, press fitting or the like. A washer and a bushing (both not shown) may exist inside or just outside the manifold 300. The bushing of the manifold 300 may be identical to the bushing used within the swiveled fluid conduit pathway 1. The washer may be the same as is used in the connector described earlier.

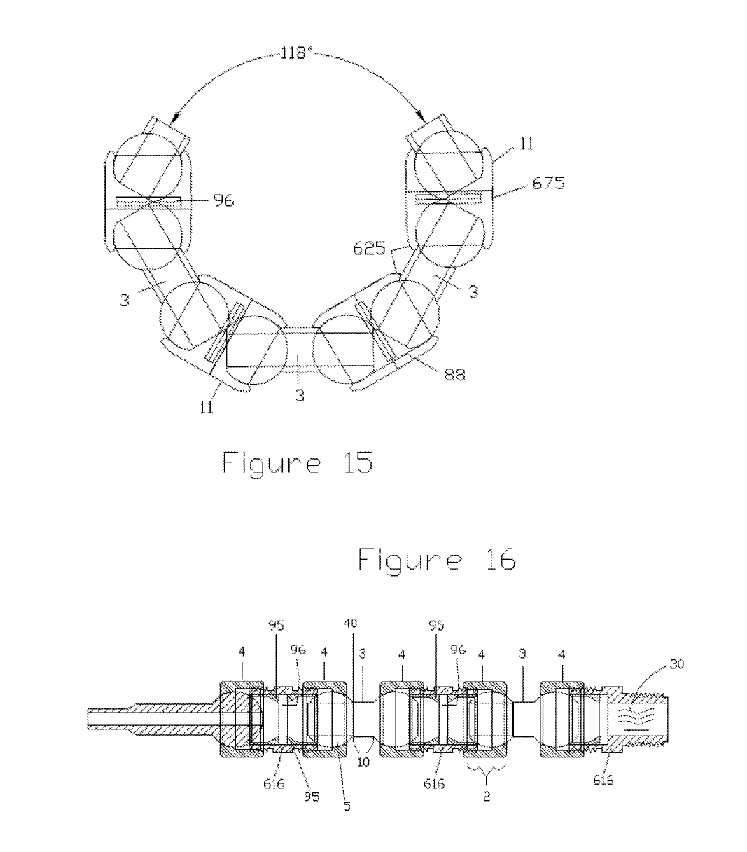

Referring now to FIGS. 12 and 15, in an embodiment, a space 815 between nut portions 4 may be lacking in the system 1. In this embodiment, the two nut portions 4 may be in direct contact with each other. More specifically, one nut portion 4 may screw or be secured by other means directly into the second nut portion 4. In this embodiment, the nut portions 4 may be essentially identical except one may have a male thread and the other a corresponding female thread. In this embodiment, the male thread may have a slightly smaller circumference 940 around an end such that the smaller circumference 940 may slide into and be secured within the slightly larger circumference 941 of the female nut portion 4. Other securing systems may use a similar method without using the thread itself. As a result, the connecting points of the fluid passageway 50 may be reduced. Further, end points of the nut portions 4 may be angled 625 so as to allow the connecting portion to rotate further and come into closer proximity with a neighboring connecting portion (as is visible in FIG. 9). Further, a knurl may be present on the outer surface of at least one of the nut portions. The knurl may allow a user to manually tighten or loosen the first nut 600 from the second nut 601. More specifically, the user may attach or separate the first nut portion 600 from the second nut portion 601 without the need for a wrench or other tool for securing the seal. A rubber gasket or other seal 675 (FIG. 15) and bushings (not shown) may separate the first nut portion 600 from the second nut portion 601 to create an air/fluid tight seal.

FIG. 20a illustrates normal flow of the liquid 30 through the swiveled fluid conduit pathway 1 when the swiveled fluid conduit pathway 1 is generally in a straight line. During this configuration, the flow of the liquid 30 through the ball-joint assembly units 2 has little or no disturbance. FIG. 20b illustrates the downward taper 81 of the lip 22 of the nut 4 preventing the generally straight cylindrical portions 3 from further rotation, therein reducing the angle of the swiveled fluid conduit pathway 1. As a result, the flow of the liquid 30 through the ball joint assembly units 2 has relatively low disturbance. FIG. 20c illustrates what would happen if the downward taper 81 of the lip 22 portion were too great or non-existent. More specifically, the ball-joint assembly unit 2 may rotate too far, therein cutting off access to some of the passageway 50 of the ball-joint assembly unit 2 and reducing flow and/or altering pressure of the liquid 30. The smaller, non-parallel lines (ie: non-parallel with respect to the passageway 50), represents areas of decreased pressure and decreased liquid 30 flow if the lip 22 portion were not present or was too small. In FIG. 20c, the liquid 30 may also be blocked by the sidewall of the bushing 95 or by the nut housing holder 616 that the nut 4 secures to if the lip 22 portion were not present or too small.

Although embodiments of the present invention are shown and described therein, it should be understood that various changes and modifications to the presently preferred embodiments will be apparent to those skilled in the art. Such changes and modifications may be made without departing from the spirit and scope of the present invention and without diminishing its attendant advantages. It is, therefore, intended that such changes and modifications be covered by the appended claims.

I claim:

1) An adjustable fluid swivel conduit system having:
a first ball joint assembly unit having an interior;
a ball having a hollow interior passageway located within the first ball-joint assembly unit;
a generally cylindrical portion secured to the ball wherein the generally cylindrical portion has a hollow interior passageway and wherein the passageway of the ball and the passageway of the generally cylindrical portion are aligned and form a continuous pathway wherein a fluid may pass through;
a second ball joint assembly unit having an interior;
a second ball having a hollow interior passageway located within the second ball joint assembly unit;
a second generally cylindrical portion secured to the second ball of the second ball joint assembly unit wherein the second generally cylindrical portion has a hollow interior passageway and wherein the passageway of the second ball and the passageway of the second generally cylindrical portion are aligned and form a continuous pathway wherein a fluid may pass through;
a nut housing holder having a generally cylindrical interior wherein the nut housing holder secures the first ball joint assembly unit to the second ball-joint assembly unit; and
a first nut secured to the nut housing holder and a second nut secured to the nut housing holder and wherein the first ball joint assembly unit and second ball-joint assembly unit are identical and mirror each other in spatial orientation.

2) The adjustable fluid swivel conduit system of claim 1 wherein the adjustable fluid swivel conduit system is constructed from a corrosive-resistant or corrosive-proof metal or a plastic.

3) The adjustable fluid swivel conduit system of claim 1 further comprising:
a series of flat surfaces or knurl on an exterior of the first nut and an exterior of the second nut.

4) The adjustable fluid swivel conduit system of claim 1 further comprising:
a first bushing and a second bushing located within the interior of the nut housing holder wherein the first bushing and second bushing are identical and mirror each other in spatial orientation.

5) The adjustable fluid swivel conduit system of claim 4 further comprising:
a washer located between the first bushing and the second bushing of the nut housing holder.

6) The adjustable fluid swivel conduit system of claim 1 further comprising:
a thread on an exterior of the nut housing holder wherein the thread mates with a corresponding groove located within an interior of the first nut and an interior of the second nut and wherein the thread secures the first nut to the nut housing holder and secures the second nut to the nut housing holder.

7) The adjustable fluid swivel conduit system of claim 1 further comprising:
a tapered portion on an exterior portion of the first nut and a tapered portion on an exterior portion of the second nut wherein the tapered portion of the first nut and the tapered portion of the second nut allow the adjustable fluid swivel conduit system to bend at an angle greater than a non-tapered nut.

8) The adjustable fluid swivel conduit system of claim 1 further comprising:
a nozzle secured to the first generally cylindrical portion.

9) The adjustable fluid swivel conduit system of claim 5 wherein the washer is constructed of a rubber.

10) The adjustable fluid swivel conduit system of claim 1 further comprising:
a second nut housing holder having two ball joint assembly units wherein the second nut housing holder and the first nut housing holder are separated by the first generally cylindrical portion connected to the first ball.

11) The adjustable fluid swivel conduit system of claim 10 wherein the first nut housing holder and second nut housing holder are at an angle less than 180 degrees.
